(19) United States
(12) Patent Application Publication
(10) Pub. No.: US 2004/0177541 A1
(43) Pub. Date: Sep. 16, 2004

(54) Ad stand

(76) Inventor: Jon Malecker, Salt Lake City, UT (US)

Correspondence Address: JON MALECKER, 723 WINDSOR ST., SALT LAKE CITY, UT, 84102, US

(21) Appl. No.: 10/794,670

(22) Filed: Mar. 4, 2004

Related U.S. Application Data
(60) Provisional application No. 60/453,850, filed on Mar. 12, 2003.

(51) Int. Cl. G09F 11/02; G09F 3/20

(52) U.S. Cl. 40/611.06; 40/649

(57) ABSTRACT

An article of manufacture for reading assistance and advertising. It is a free standing clear or tinted plastic device that has a magnifying lens built in and an area that will accept a removable or permanent advertisement. The bottom is flared out on each side enabling it to be free standing. From the flared out bottom the device rises vertically and this is the location of the magnifying and advertising areas. The predominant sizes of the device will range from 2 inches to 10 inches tall and from 2 inches to 6 inches wide, the magnifying portion is not removable and is placed or scribed in the plastic at the time of manufacture. There is a slot in the plastic which allows an advertising card to be slid in, or a permanent advertisement is placed in the plastic at the time of manufacture.

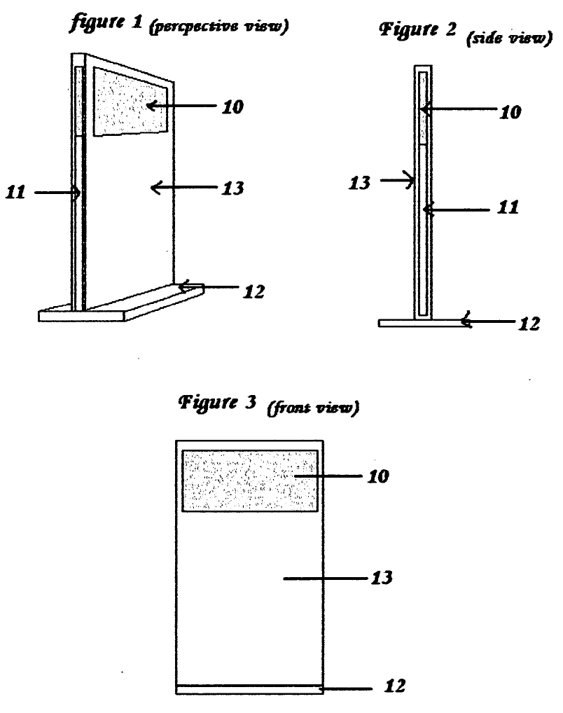

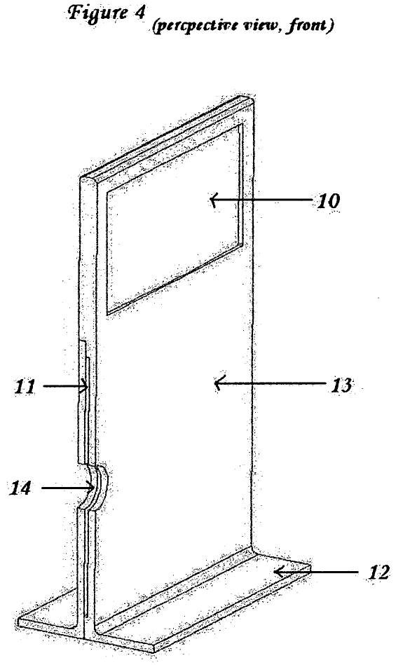

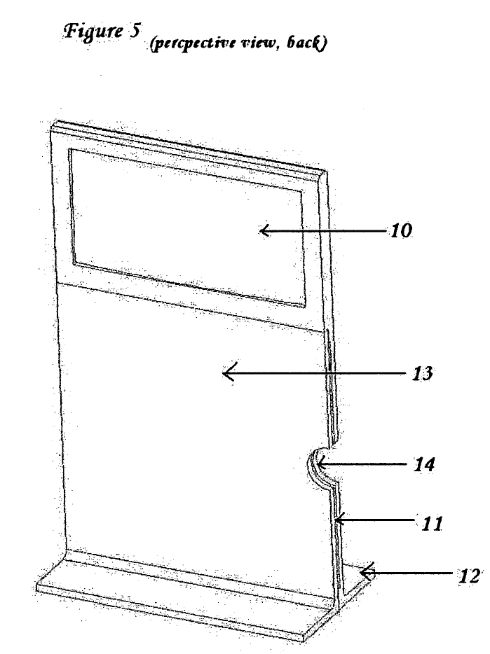

### CROSS REFERENCE TO RELATED APPLICATIONS

This application is based on provisional application serial No. 60/453,850, filed on Mar. 12, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of vision and more specifically to an article of manufacture for reading assistance and advertising. It is a free standing clear or tinted plastic device that has a magnifying lens built in it and an area which will accept a removable or permanent advertisement.

This device was invented because of the frustration a person goes through whenever your reading glasses are not handy and reading something is necessary. For example, trying to read a menu in a restaurant is impossible for some people if they forgot their glasses. However, the restaurant could help their customers and also help themselves with this device. The customer can use it for reading assistance and the advertisement on the device will be seen by many more people because of the eye catching design of the device.

Nearly all retail establishments have plastic advertising devices because they are cheap and an easy way to advertise.

None of the table top advertising devices have incorporated a magnifying lens such as this invention has.

### BRIEF SUMMARY OF THE INVENTION

The primary object of the invention is to provide a free standing multi-function plastic device for table tops and retail counters.

Another object of the invention is to provide reading assistance by looking through the magnifying lens area.

Another object of the invention is to provide reading assistance by looking through the magnifying lens area from either side.

A further object of the invention is to provide an advertising area which can accommodate a removable card.

Yet another object of the invention is to provide an advertising area which can hold a permanent advertisement.

Still yet another object of the invention is to provide a device which, because of its design with the magnifying lens conspicuously displayed, will attract the attention of many people.

Another object of the invention is to enable advertisers to benefit from the attention the device gets.

Another object of the invention is to provide advertisers with a clear plastic device whereby their ad or ads come be seen from either side.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for reading assistance and advertising. It is a free standing clear or tinted plastic device that has a magnifying lens built in it and an area which will accept a removable or permanent advertisement comprising: made from clear or slightly tinted plastic so it can be seen through, the bottom is flared out on each side which allows it to be free standing, from the flared out bottom the device rises vertically and this is where the magnifying and advertising areas are located, the predominant sizes of the device will range from 2 inches to 10 inches tall and from 2 inches to 6 inches wide, the magnifying portion is not removable and is placed or scribed in the plastic at the time of manufacture, there is a slot in the plastic to allow an advertisement card to be slid in and out, or a permanent advertisement is placed in the plastic at the time of manufacture.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The invention is a free standing see through plastic device which incorporates a magnifying lens area 10, and an area designed to hold an advertisement which is readable from both sides 13. The bottom of the device 12, is flared out allowing it to stand freely. When the device is standing upright the magnifying area 10, and advertising area 13, are located above the flared out bottom. The magnifying lens 10, is not removable and is sandwiched in the middle of the plastic. The lens is glued, welded, scribed or stamped into the plastic at the time of manufacture and is 2 to 7 times magnification. The magnifying area 10, could be located anywhere in the device but the top of the device is where it is most noticeable and easiest to use and that is where it is anticipated to be located. There will be a slot 11, through the plastic below the magnifying area of approximately 1/16-⅛ inch wide which is designed to hold a two sided advertising card. This card is removable and can be seen from either side of the device. To assist in the removal of the card a half circle cut out area 14, may be incorporated in the design. A permanent advertisement can be placed in the device at the time of manufacture also, if desired. The device can be of many sizes and shapes however, the predominant size will be 2 inches to 10 inches tall and 2 inches to 6 inches wide.

The device is designed for restaurant table tops or any venue that would benefit from the two function design. The device will be picked up and used by individuals that want to look through the magnifying lens 10, for reading assistance and the device will benefit the advertiser whenever someone reads the ad in the device. Because of the unusual appearance of this device the advertisement in it will get allot of attention. The device can be made several ways. Sheets of 1/16 inch to ⅛ inch thick plastic can be cut to size heated and bent to the proper shape and glued together. In this method the magnifying lens will be a separate piece and placed between the bent plastic before its glued together. The device can also be made from a mold with liquid plastic being poured into the mold. In this case the lens will be formed into the plastic at the time its being manufactured.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for reading assistance and advertising it is a free standing clear or tinted plastic device that has a magnifying lens built in it and an area which will accept a removable or permanent advertisement comprising:
made from clear or slightly tinted plastic so it can be seen through;
the bottom is flared out on each side which allows it to be free standing;
from the flared out bottom the device rises vertically and this is where the magnifying and advertising areas are located;
the predominant sizes of the device will range from 2 inches to 10 inches tall and from 2 inches to 6 inches wide;
the magnifying portion is not removable and is placed or scribed in the plastic at the time of manufacture;
there is a slot in the plastic to allow a advertisement card to be slid in and out, or; and
a permanent advertisement is placed in the plastic at the time of manufacture.
